(19) United States
(12) Patent Application Publication
(10) Pub. No.: US 2026/0170355 A1
(43) Pub. Date: Jun. 18, 2026

(54) AUTOMATED RULE GENERATION WITH LIMITED TREE TRAVERSAL

(71) Applicant: PayPal, Inc., San Jose, CA (US)

(72) Inventors: Charles Poli, London (GB); Shreekanthadatta Eligar, Hyderabad (IN); Lokesh Nyati, Dharwad (IN)

(21) Appl. No.: 18/986,198

(22) Filed: Dec. 18, 2024

(51) Int. Cl. G06N 5/01; G06Q 20/40; H04L 9/40

(52) U.S. Cl. CPC G06N 5/01; G06Q 20/4016; H04L 63/14

(57) ABSTRACT

Automated rule set generation is disclosed. A computer generates a rule by selecting a feature of a dataset of training data having a plurality of features and by creating, based on the feature, a root node of a decision tree. The root node is associated with a root node decision condition. The computer associates, based on the root node decision condition, events in the dataset with one or more root-level branches from the root node. The computer selects one of the one or more root-level branches as a selected root-level branch, with any remaining root-level branches constituting unselected root-level branches. The computer creates nodes at (n−1) levels descending from the selected root-level branch without creating nodes descending from the unselected root-level branches. The computer evaluates information gains of nodes at a depth of n levels of the decision tree to determine a first n-condition rule of the rule set.

### BACKGROUND

### Technical Field

This disclosure relates generally to artificial intelligence and, more particularly, to automated rule generation through application of machine learning techniques.

### Description of the Related Art

Computer-based decision-making using rules is a systematic approach that leverages predefined logical statements or algorithms to evaluate data and automate choices in various applications. This method often employs rule-based systems, allowing computers to analyze input data and generate outputs based on established criteria. Such systems are commonly used in expert systems, business process automation, and artificial intelligence applications, where they can efficiently handle complex tasks such as diagnosing medical conditions, managing inventory, or optimizing logistics. By encoding expert knowledge into rules, organizations can enhance consistency, speed, and accuracy in decision-making processes. Additionally, rule-based decision-making allows for easy updates and modifications as new information or conditions arise, making it a flexible and adaptive solution in rapidly changing environments.

Rules for computer decision-making can be generated by either humans or machines. Human-generated rules typically stem from expert knowledge, domain experience, and a deep understanding of the specific context in which decisions are made. These rules are often crafted through collaborative processes, ensuring that nuanced insights and practical considerations are incorporated. On the other hand, machine-generated rules emerge from algorithms that analyze vast datasets to identify patterns and correlations, often employing techniques such as machine learning. This automated approach can rapidly produce rules based on empirical evidence, potentially uncovering insights that human experts might overlook. While human-generated rules may excel in areas requiring context and creativity, machine-generated rules can adapt quickly to new data and evolving scenarios. In many scenarios, most or all rules in a computer decision-making process may be computer-generated.

### BRIEF DESCRIPTION OF THE DRAWINGS

FIG. 1A is a block diagram of one embodiment of an automated rule generation engine.

FIG. 1B is an example of a dataset.

FIG. 1C is an example of a tree data structure that may be produced by a rule generator.

FIG. 2 is a block diagram of one embodiment of an automated rule generation engine.

FIG. 3A is a block diagram of one embodiment of a decision stump training module.

FIG. 3B illustrates an example of a decision stump.

FIG. 3C is a block diagram of one embodiment of decision stump training module that includes a root node selection module and a root node branch generation module.

FIG. 3D is a table that is an example of root nodes instantiated based on the first-condition quantile approach.

FIG. 3E is a table illustrating an example of a plurality of root nodes instantiated based on a particular feature set and another table illustrating an example of a plurality of root nodes instantiated in accordance with the first-condition quantile approach.

FIG. 4 is a block diagram of one embodiment of a decision tree training module.

FIG. 5 is a block diagram of one embodiment of a rule formation module and a rule set optimization module.

FIG. 6 is a block diagram of a tree data structure generated as an output of the disclosed rule generation engine.

FIG. 7 is a flow diagram of one embodiment of a method for automated rule generation.

FIG. 8 is a flow diagram of one embodiment of a method for automated rule generation.

FIG. 9 is a flow diagram of one embodiment of a method for automated rule generation.

FIG. 10 is a block diagram of another embodiment of such a computer system.

### DETAILED DESCRIPTION

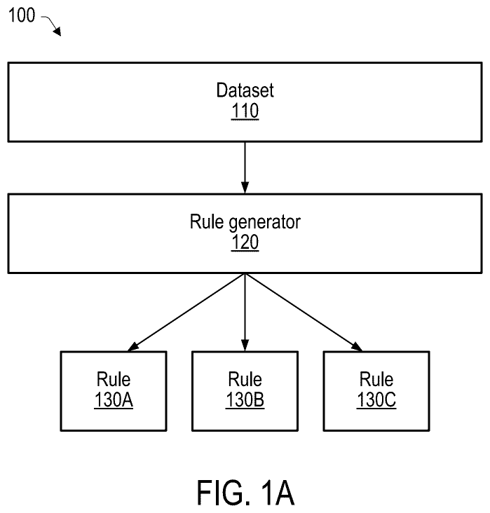

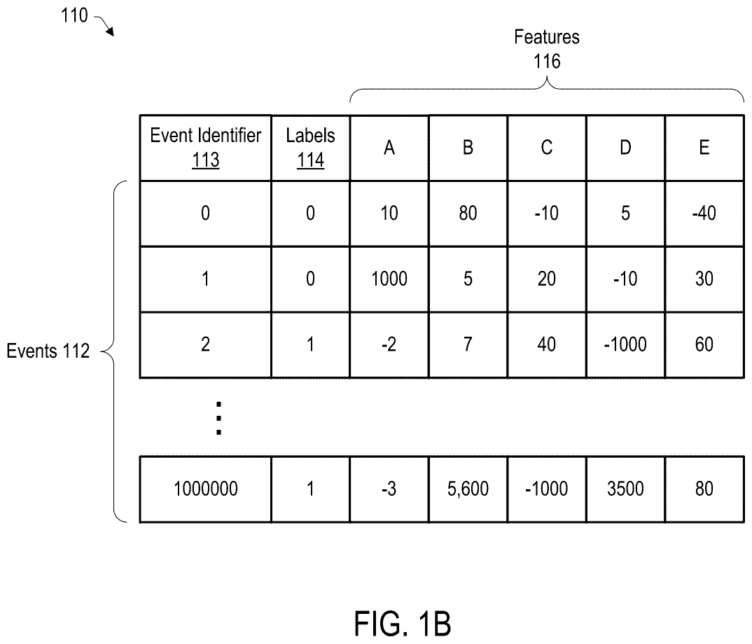

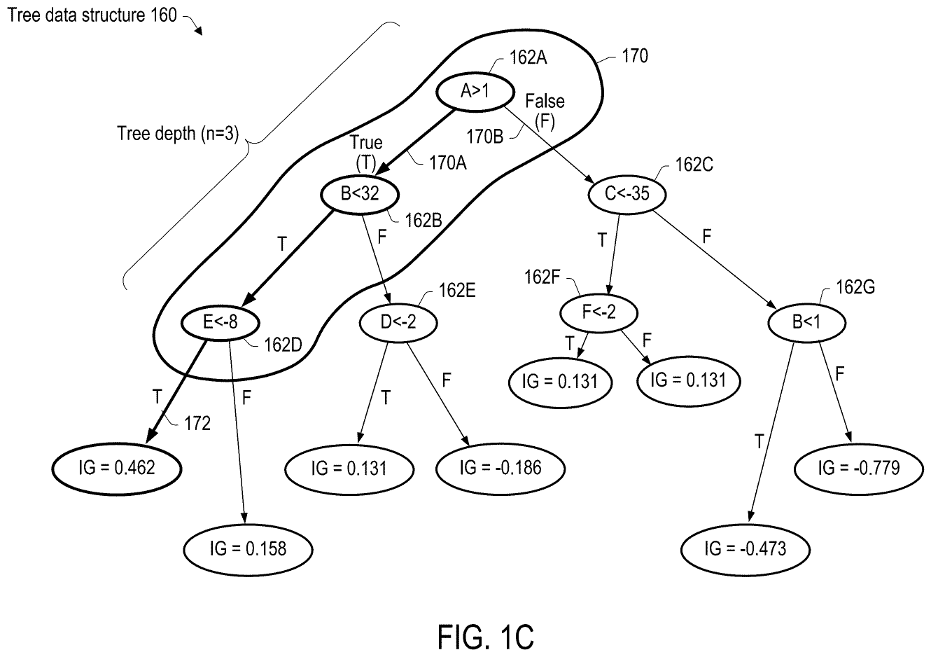

FIG. 1A is a block diagram of one embodiment of an automated rule generation engine. As depicted, automated rule generation engine 100 includes rule generator 120, and operates on dataset 110 to produce rules 130A-C. Collectively, rules 130A-C may be referred to as rule set 130.

Dataset 110 includes training data composed of different events, the constituent data of which may be considered to be features. Each event may be labeled for training purposes. An example of dataset 110 is provided below with respect to FIG. 1B.

In various embodiments, rule generator 120 is executable to use dataset 110 to create one or more tree data structures, each of which is used to generate a respective rule. As used herein, a “tree data structure” is a hierarchical data structure having a plurality of nodes, wherein a “node” is associated with a set of data. A “parent” node is a node having one or more “child” nodes at a lower level of the data structure, each child node inheriting some characteristics of the parent node or some data included in the parent node. A “root” node of the tree data structure is a node at the highest level of the data structure and which thus has no parent node. Nodes in a tree data structure are connected by “branches,” where a “branch” of the tree relationally associates two nodes.

As noted, in the depicted embodiment, rule generator 120 generates a plurality of rules 130A-C. Rule generator 120 may thus implement a Random Forest machine learning technique, in which the output of multiple decision trees is combined to reach a single result. Each decision tree in the Random Forest is built using the training data and a subset of features, which enhances model diversity and reduces the risk of overfitting. The trees are used to create a series of rules that dictate how decisions are made based on the input features. When making predictions, the Random Forest combines the outputs of all its decision trees. This method not only captures complex interactions and non-linear relationships in the data but also provides insights into feature importance, helping users understand which variables most influence the outcomes.

FIG. 1B is an example of dataset 110. As depicted, dataset 110 includes data for a set of events 112, where each row in FIG. 1B includes data for a different event. A given event 112 has an event identifier 113, a label 114, and values for features 116.

An event 112 in the context of dataset 110 for automated rule generation engine 100 refers to an instance of training data that is usable to train a machine learning model. A given instance of training data may have either been generated or may be empirical data that has gathered during actual use of some computer system. The nature of an event in a particular system depends upon the nature of automated rule generation engine 100. For example, in an engine designed to stop malicious network traffic, an event may correspond to a network communication (e.g., source IP address, destination IP address, ports involved, etc.). As noted, the network communication in question may have been one that occurred on some system, or it may be a “synthetic” communication, meaning that the communication never actually occurred and the instance of training data has properties to be expected in an actual network communication.

Event identifier 113 is a value associated with an event to facilitate look-up of the event. For example, a computer system may store dataset 110 in a memory, and event identifier may be useable by the computer system to look-up and retrieve the event.

Labels 114 are associated with each event and categorize the event. Dataset 110 thus constitutes “labeled” training data in that it can be used to train a classifier that predicts whether future events fall into a particular category or not. For instance, a label “0” may identify an event as being a computer security threat or a fraudulent transaction. In contrast, a label “1” may identify an event as being benign software or a legitimate transaction. Reverse polarities may also be employed (e.g., “1” designates fraudulent transaction). As will be described below, labels 114 are used to assess how accurately different rule components are in characterizing dataset 110.

Each event in dataset 110 is associated with values for a set of variables, which are referred to in the machine learning context as “features.” There are five features 116 within dataset 110: A, B, C, D, and E. The cumulative set of features for dataset 110 is referred to herein as the “feature set” of that dataset. In a context in which an event corresponds to a computer security threat, a feature may be a characteristic of the computer security threat (e.g., a memory address at which the computer security threat was located) and associated feature value may correspond to a memory address. As another example, in a context in which an event corresponds to a financial transaction, a first feature may identify an amount (e.g., a dollar figure) associated with the transaction while a second feature may identify an item associated with the transaction (e.g., a model number). Note that features may intrinsically have non-numeric values (e.g., server name), but such values are converted (encoded) to numerical values for purposes of dataset 110. Additionally, while five features are shown, an event may include fewer features or more features.

FIG. 1C is an example of a tree data structure that may be produced by a rule generator. Depicted in FIG. 1C is tree data structure 160, such as might be produced by rule generator 120. Tree data structure 160 is useable to generate a rule that includes conditions. For example, as depicted in FIG. 1C, a rule corresponds to the set of ordered conditions {A>1, B<32, E<−8}, explained more fully below.

As depicted, tree data structure includes plurality of nodes 162A-G. Node 162A is a root node, while nodes 162B and 162C are child nodes of root node 162A. A child node is relationally associated with a parent node via a branch or edge. For instance, child node 162B is associated with root node 162A through root-level branch 170A. Data structure formats for tree data structures are well understood in the art. Note that a node may be both a child node and a parent node. Node 162B is a child of node 162A, and a parent of nodes 162D-E.

Certain nodes 162 in tree data structure 160 are associated with node decision conditions. The node decision conditions shown in FIG. 1C are binary conditions that may be true (T) or false (F). As shown, each node decision condition includes three parts: a feature, an operator, and a threshold. The node decision condition for node 162A, for example, is A>1. The feature is “A,” the operator is the inequality “greater than,” and the threshold is 1. Note that while the example of FIG. 1C depicts an inequality operator, operators are not limited to inequalities, but may be an equality, a mathematical function, a logical operator, etc.

The nodes in tree data structure 160 that have node decision conditions each have an associated pair of branches: one branch for those dataset elements that satisfy the true condition (i.e., when the node decision condition is true) and one branch for those dataset elements that satisfy the false case (i.e., when the node decision condition is false). For example, root node 162A has root-level branches 170A-B for the true (A>1) and false (A≤1) cases, respectively.

Tree data structure 160 has three levels of nodes that have node decision conditions. As such, tree data structure 160 is usable to generate a 3-condition rule, and thus tree data structure 160 can be said to have a tree depth of 3. More generally, the tree depth parameter for a given tree can be referred to by the variable n.

To derive a rule from tree data structure 160, training datasets may be applied to the node decision conditions within structure 160. Consider an example in which a training dataset has 1000 labeled events. Application of the training dataset to node 162A produces two filtered datasets: the first filtered dataset would correspond to those ones of the 1000 original events for which the node decision condition associated with node 162A is true, while the second filtered dataset would correspond to those remaining ones of the 1000 events for which the node decision condition associated with node 162A is false. In one instance, application of node 162A to the training dataset might cause 400 of 1000 events to be grouped in the first filtered dataset, and the remaining 600 of 1000 events to be grouped in the second filtered dataset.

This process continues for remaining nodes of tree data structure 160. First filtered dataset is applied to node 162B, which might produce a third filtered dataset (B<32) having 250 of 400 events of the first filtered dataset and a fourth filtered dataset (B≥32) having the remaining 150 out of 400 events. The 600 events of the second filtered dataset are similarly applied to node 162C, with binning into fifth and sixth filtered datasets. One possible distribution of the 1000 events to the eight branches originating from leaf nodes 162D-G is, from left to right, 200 events (T branch of node 162D), 50 events, 80 events, 75 events, 125 events (T branch of node 162F), 375 events, 60 events, and 40 events.

As shown, an “information gain” (IG) may be computed for each branch of nodes 162D-G. Note that in some implementations, the branches of nodes 162D-G point to (unlabeled) nodes in tree data structure 160 that do not have associated node decision conditions and which are associated with “final” filtered data sets resulting from evaluation of node decision conditions at level n. In other implementations, the branches of nodes 162D-G do not point to nodes, but instead point to final filtered datasets.

In order to understand the concept of IG, it is first instructive to consider the related concept of entropy of a dataset. The concept of entropy which is well understand in the context of machine learning, describes the amount of purity in a dataset relative to the characteristic that is to be predicted. Consider two training datasets of 10 events that are useable to predict transaction fraud: the first dataset has nine fraud examples, while the second dataset has five fraud examples. The second dataset has a lower entropy than the first dataset, because there is a greater amount of purity (or, conversely, less randomness) in the dataset.

As is understood in the art, for a binary classification problem, the following equation may be used for calculating entropy: −p*log₂(p)−(1−p)*log₂(1−p), where p represents the proportion of one class in the data set. Entropy for the first and second datasets listed above would thus be calculated as follows, where p₁=9/10=0.9 and p₂=5/10=0.5:

$$Entropy ( first dataset ) = - [ ( 0.9 ) ( {log}_{2} ( 0.9 ) ) ] - [ ( 0.1 ) ( {log}_{2} ( 0.1 ) ] = 0.469 ; and$$

$$Entropy ( second dataset ) = - [ ( 0.5 ) ( log 2 ( 0.5 ) ) ] - [ ( 0.5 ) ( log 2 ( 0.5 ) ) ] = 1.$$

Entropy will thus range between 0 and 1. A dataset having an entropy value of 0 indicates a dataset that has maximum purity relative to the characteristic of interest (e.g., every event corresponds to the characteristic of interest, or every event does not correspond to the characteristics of interest). In contrast, a dataset having an entropy value of 1 indicates a dataset that has a minimum purity relative to the characteristic of interest—which is the case for the second dataset, in which half of the events of the dataset correspond to the characteristic of interest and the other half of events do not.

Information gain, on the other hand, measures the change of entropy within a decision tree. In terms of the branches of the third-level nodes in FIG. 1C, the goal is to identify the path (i.e., a series of branches corresponding to node decision conditions) that achieves the highest possible homogeneity in the dataset corresponding to these branches. Such a path will have the greatest information gain for its filtered dataset relative to the original dataset. It is well understood in the art how to compute information gain within a decision tree. Consider the example of the second training dataset given above (5 fraud events/5 non-fraud events). A branch of a third-level node that has a filtered dataset with 4 fraud events and 1 non-fraud event will have a higher IG than another branch that has a filtered dataset with 3 fraud events and 2 non-fraud events. The former branch has resulted in a filtered dataset with greater purity and order—in other words, the greater reduction in entropy relative to the latter branch.

Information gain may assume either positive or negative values. A positive information gain indicates decreasing entropy as a decision tree is traversed, while a negative information gain indicates increasing entropy as a decision tree is traversed. Accordingly, in some cases, a set of conditions applied to datasets may reduce entropy relative to the entropy of the initial dataset, thereby resulting in positive information gain. In other cases, however, a set of conditions applied to datasets may increase entropy relative to the entropy of the initial dataset, thereby resulting in negative information gain.

To instantiate a rule, rule generator 120 may select a branch associated with the greatest information gain. For instance, rule generator 12 may select branch 172, since branch 172 is associated with the greatest information gain value among the branches of tree data structure 160. Selected rule 170 thus is comprised of ordered conditions A>1, B<32, and E<−8, which correspond to the path from root node 162A to node 162D.

The present disclosure identifies, however, as a problem, that rules generated as described with reference to FIGS. 1A-C tend to be similar to one another. Consequently, results generated by applying different rules of such a rule set to a dataset tend to be highly correlated. For instance, a first result generated by applying a first rule of the rule set to a dataset is likely to be highly correlated with a second result generated by applying a second rule of the rule set to the dataset.

Correlation may be measured by a correlation coefficient having a value between −1 and 1. In this context, the first result is said to be anti-correlated with the second result if a value of the correlation coefficient calculated based on the first result and the second result equals −1. Similarly, the first result is said to be correlated with the second result if the correlation coefficient calculated based on the first result and the second result equals 1. The first result is said to be uncorrelated with the second result if the correlation coefficient calculated based on the first result and the second result equals 0. Thus, results having correlation coefficients that are close to 0 tend to be uncorrelated, while results having correlation coefficients close to −1 or 1 are anticorrelated and correlated, respectively.

Hence, in general, because rules of a rule set generated as described with reference to FIGS. 1A-C tend to be similar to one another, the results of applying these rules to a dataset can tend to be correlated. Accordingly, if one rule of the rule set fails to identify a pattern in empirical data, other rules of the rule set are likely to likewise fail to identify the pattern. Consequently, due to this relatedness among the rules of the rule set, the pattern-detection characteristics of the rule set are attenuated.

The present disclosure thus proposes a paradigm in which each feature of a dataset or in which a majority of features of the dataset are used as a root node decision condition of a root node in instantiated tree data structures. For example, all or a majority of features A-E shown in FIG. 1B may be used as root nodes in different tree data structures to generate rules of a rule set. The present disclosure recognizes that rule sets that contain rules generated in this manner tend to have less similarity among one another than rules generated as described with reference to FIGS. 1A-C. Therefore, results generated by applying rules of these rule sets to datasets tend to be less correlated with one another than results generated by applying rules of rule sets generated as described with reference to FIGS. 1A-C. Accordingly, rule sets generated in accordance with the techniques of the present disclosure advantageously tend to be better suited to detecting patterns in these datasets than rule sets generated via traditional techniques.

Additionally, the present disclosure recognizes, that implementing these techniques with multiple root nodes over a plurality of tree data structures can lead to greater numbers of tree structures, and thus increased computational requirements. Accordingly, the present disclosure proposes that, after applying the node decision condition for a root node of a tree structure to a dataset, the computer may select a single root level branch, among true and false root-level branches, upon which to perform further processing. The result is that the tree is not further processed with respect to the unselected root level branch. This processing of the root node of a decision tree in isolation, before conducting further processing, is referred to as training a “decision stump.” As will be described, an information gain is computed for each root-level branch, and only the root-level branch having the greatest information gain is selected for further processing. Nodes will thus be created at levels descending from the selected root-level branch, but nodes will not be created at levels descending from the unselected root-level branches.

By selecting a root-level branch on which to perform further processing while not performing further processing on the unselected root-level branches, temporal and computational resources may be conserved, thereby reducing an amount of time expended to generate a rule set as compared with traditional rule generation techniques. In this manner, the need to process more decision trees may be offset by reduced processing requirements per tree as compared to traditional approaches such as that shown in FIG. 1C in which the entire tree is processed. In this manner, a set of rules may be generated that, when applied to datasets, generate results that are relatively loosely correlated with one another, with a reasonable amount of processing power and within a reasonable period of time.

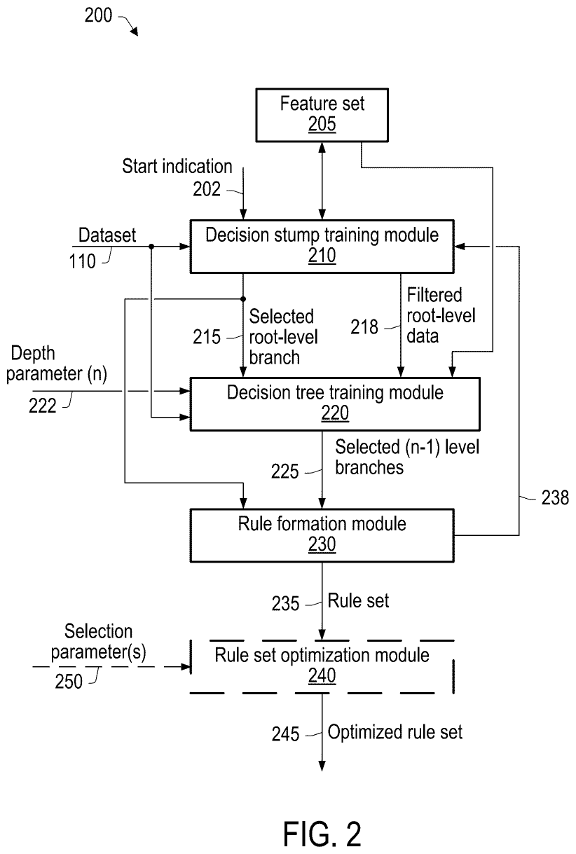

FIG. 2 is a block diagram of one embodiment of an automated rule generation engine. As depicted in FIG. 2, automated rule generation engine 200 includes decision stump training module 210, decision tree training module 220, and rule formation module 230. In some embodiments, engine 200 may include rule set optimization module 240. As noted, feature set 205 is the cumulative set of features of dataset 110. Automated rule generation engine 200 is operable to generate one or more n-condition rules, wherein n is the tree depth. Decision stump training module 210 is operable to receive dataset 110, feature set 205, and start indication 202. Decision stump training module 210 is operable to instantiate a decision stump by selecting, from feature set 205, a feature to be associated with the decision stump, which is the root node of the tree being formed. The decision stump will also be associated with an operator and a threshold (e.g., A<1, E>32, etc.). Decision stump training module 210 is further operable to apply the node decision condition to dataset 110 for both the true and false root-level branches descending from the decision stump. This approach separates dataset 110 into two filtered datasets. A first of these filtered datasets corresponds to those events within dataset 110 that are true, while a second filtered data corresponds to those events within dataset 110 that are false.

Further, decision stump training module 210 is operable to select, from among its two root-level branches, a root-level branch as selected root-level branch 215. Selected root level branch 215 corresponds to the root node decision condition (e.g., A<1). As will be described, selected root-level branch 215 will be used by decision tree training module 220 to perform processing on the portion of the tree corresponding to selected root-level branch 215. Decision tree training module 220 will ignore the non-selected root-level branches, such that no further processing is performed on the portion of the tree corresponding to the non-selected root-level branch. When selected root-level branch 215 is selected, a filtered root-level dataset 218 is also passed to decision tree training module 220. Filtered root-level dataset 218 represents those events of dataset 110 that satisfy the condition for selected root-level branch 215.

Decision tree training module 220 is operable to receive an indication of selected root-level branch 215 and filtered root-level dataset 218 from decision stump training module 210. Additionally, decision tree training module 220 is operable to receive depth parameter 222. Depth parameter 222, n, indicates a depth of the decision tree, and decision tree training module 220 is operable to generate n−1 additional levels of the decision tree below the root node. For example, if depth parameter 222 is indicated as being four, decision tree training module 220 is operable to instantiate three additional branches of nodes below the decision stump instantiated by decision stump training module 210. As will be described below, once these nodes have been created, decision tree training module 220 is further operable to select, from among a plurality of branches at the nth-level of the tree, selected n-level branches 225.

Rule formation module 230 is operable to concatenate selected root-level branch 215 and selected n-level branches 225 to form an n-condition rule. (It can be seen that a tree of n levels produces an n-condition rule since each level adds a condition to the ultimate rule.) Additionally, rule formation module 230 is operable to implement repeat instruction 238 to cause decision stump training module 210 to select another feature of feature set 205 from which to instantiate a subsequent decision stump to generate an additional n-condition rule. This process can repeat until the desired number of trees (and rules) have been generated. In this manner, rule formation module 230 is operable to output rule set 235 that includes one or more n-condition rules.

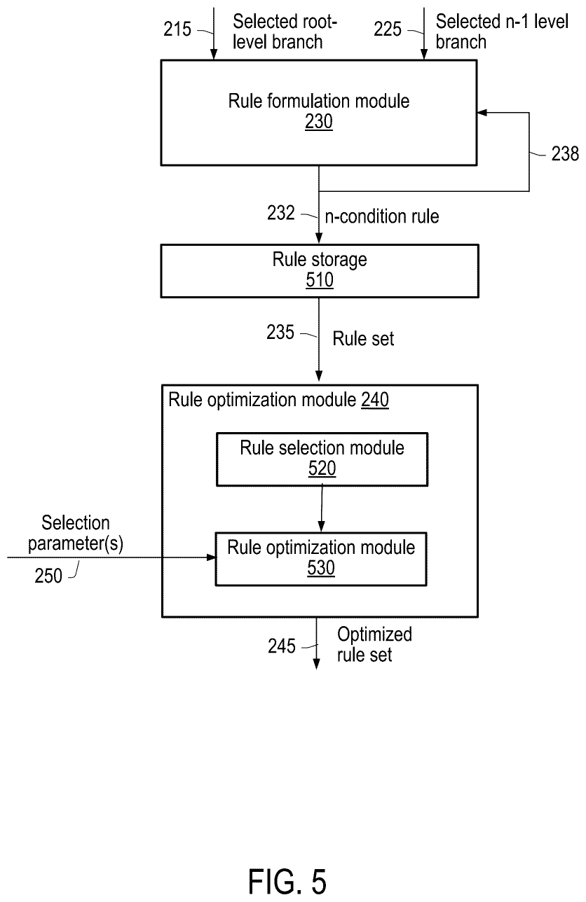

Rule set optimization module 240 is operable to select one or more rules of rule set 235 to generate optimized rule set 245. For example, rule set optimization module 240 may receive one or more selection parameter(s) 250 and may be operable to select one or more rules of rule set 235 based on selection parameter(s) 250. In some embodiments, selection parameter(s) correspond to empirical indicators of rule quality. This module is discussed further below with respect to FIG. 5.

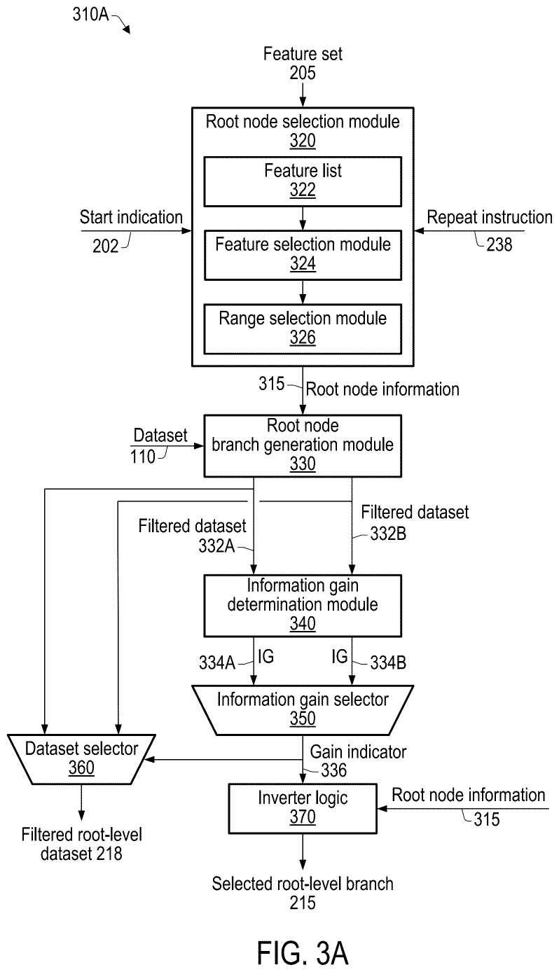

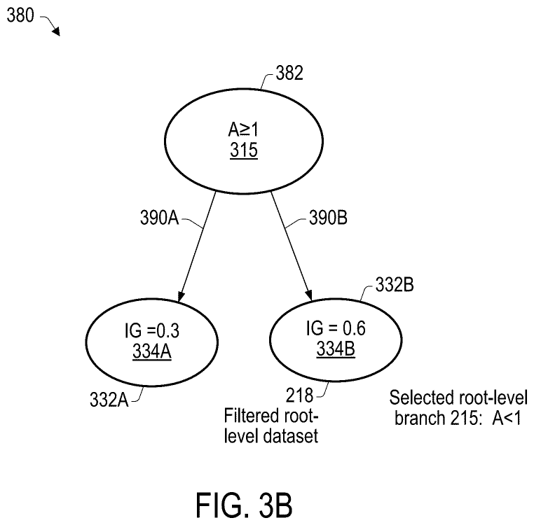

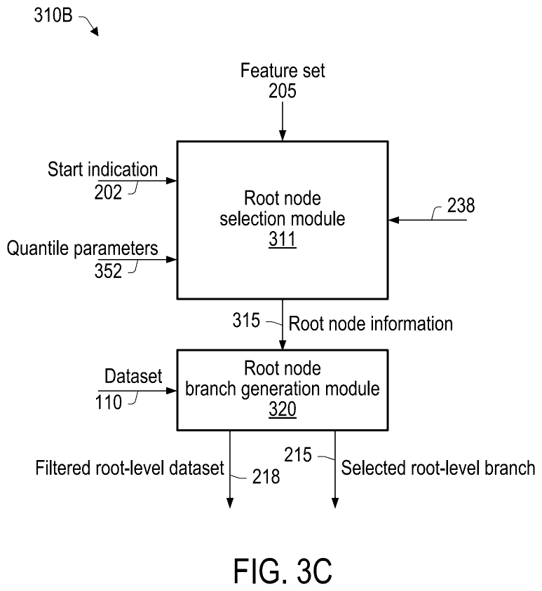

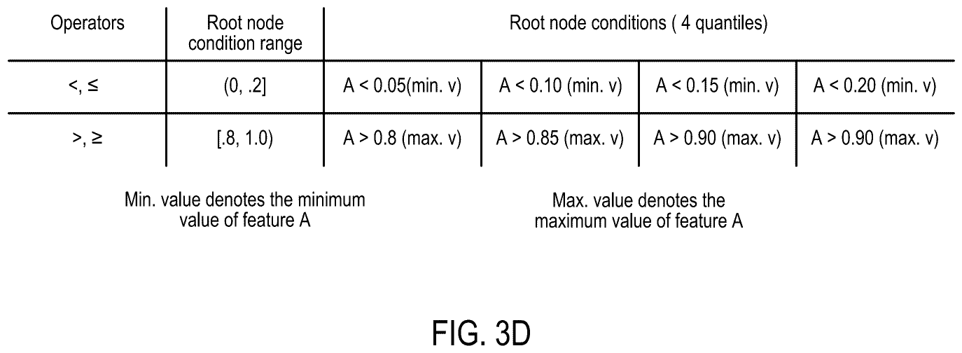

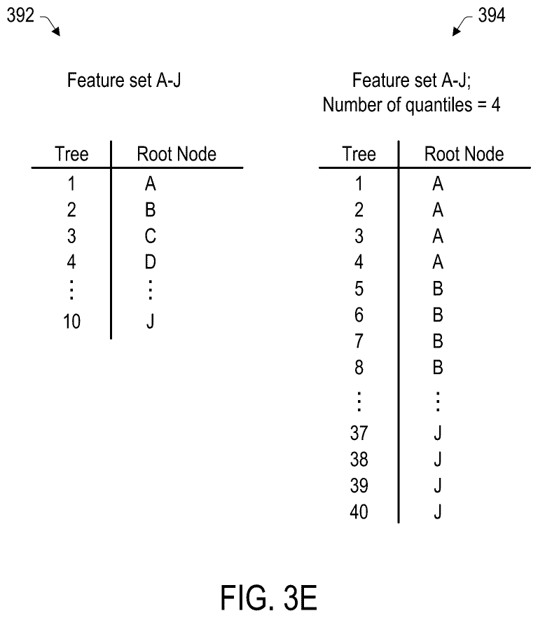

FIG. 3A is a block diagram of one embodiment of a decision stump training module. As depicted, decision stump training module 310A includes root node selection module 320, root node branch generation module 330, information gain determination module 340, information gain selector 350, dataset selector 360, and inverter logic 370. Decision stump training module 310A is operable to train a decision stump as described below.

Root node selection module 320 is operable to receive start indication 202 and feature set 205 to generate root node information 315. Root node information 315 may indicate, for example, a feature, an operator, and a threshold value associated with root node. For example, root node information 315 may specify the root node condition A≥5.

To generate root node information 315, root node selection module 320 applies functionality of feature list 322, feature selection module 324, and range selection module 325. In response to receiving start indication 202, root node selection module 320 is operable to populate feature list 322 with feature set 205 (which includes all features in dataset 110). Thus, when no root nodes have been instantiated, feature list 322 includes each feature from feature set 205.

Feature selection module 324 is operable to select a feature from feature list 324. Decision stump training module 310A uses the selected feature to instantiate a root node. In some embodiments, feature selection module 324 randomly selects a feature from feature list 322 to instantiate the root node. After selection, that feature may be removed from feature list 322, in some embodiments, so that the same feature is not used in generation of the root node in subsequent trees.

Range selection module 326 is operable to generate a root node decision condition based on the selected feature, a selected operator, and a selected threshold value. For example, range selection module 326 may generate, based on selected feature A, the root node condition A≤1 based on the selected operator (e.g., ≤) and the selected threshold. Range selection module 326 then outputs root node information 315 that specifies the root node decision condition.

Root node branch generation module 330 is operable to receive root node information 315 and dataset 110 to filter dataset 110 into filtered dataset 332A and filtered dataset 332B based on the root node condition. The root node condition is applied to dataset 110 to produce filtered datasets 332. Root node branch generation module 330 is also operable to provide information (e.g., pointers) corresponding to each of filtered dataset 332A and filtered dataset 332B to information gain determination module 340.

Consider, for instance, the root node condition A≤1. When root node branch generation module 330 applies the foregoing root node condition to dataset 110, branch generation module 330 splits dataset into filtered dataset 332A that includes instances of data from dataset 110 for which the root node condition A≤1 is true, and filtered dataset 332B that includes instances of data from dataset 110 for which the root node condition A≤1 is false. In some embodiments, root node branch generation module 330 may provide a pointer to each filtered dataset to information gain determination module 340.

Information gain determination module 340 is operable to determine information gain associated with filtered datasets. In particular, information gain determination module 340 is operable to determine information gain associated with filtered datasets 332A and 332B. To do this, information gain determination module 340 iterates through instances of data in each of filtered datasets 332A and 332B to determine an entropy of each dataset based on the instances of data. Subsequently, information gain determination module 340 compares each determined entropy to the entropy of dataset 110 to determine the information gain, for example as explained above with reference to FIG. 1C. Information gain determination module 340 thus outputs the respective information gains as information gain 334A, which is the information gain associated with filtered dataset 332A, and information gain 334B, which is the information gain associated with filtered dataset 332B.

Information gain selector 350 is operable to compare information gain determinations 334 received from information gain determination module 340 and to select the greatest information gain. Accordingly, information gain selector 350 is operable to generate gain indicator 336, identifying the filtered dataset having the greatest information gain. Gain indicator 336 may be used both to select filtered root-level dataset 218 and selected root-level branch 215.

Dataset selector 360 is operable to receive gain indicator 336. Additionally, dataset selector 360 is operable to receive information specifying filtered datasets 332A and 332B (e.g., pointers to those datasets). In response to receipt of the foregoing, dataset selector 360 is operable to output an an indication of filtered root-level dataset 218. For example, in response to gain indicator 336 identifying filtered dataset 332B as having the greatest information gain, dataset selector 360 is operable to output an indication of filtered dataset 332B (e.g., a pointer to that dataset) as filtered root-level dataset 218.

Inverter logic 370 is operable to receive gain indicator 336 and root node information 315 and to output selected root-level branch 215. Ultimately, the purpose of automated rule generation engine 200 is to generate rules that are made up of conditions. Inverter logic 370 is operable to output a condition for the root node that will subsequently be included in a rule for the tree being generated. This condition will either be the condition specified in root node information 315 (if the “true” root-level branch has the greatest information gain) or that condition's inverse (if the “false” root-level branch has the greatest information gain). Suppose that the root node decision condition specified by root node information is A≤1. If filtered dataset 332A (corresponding to the “true” root-level branch) has a greater information gain than filtered dataset 332B, then inverter logic will output A≤1 as selected root-level branch 215. Conversely, if filtered dataset 332B (corresponding to the “false” root-level branch) has a greater information gain than filtered dataset 332A, then inverter logic will output A>1 (the inverse of the root node decision condition indicated by 315) as selected root-level branch 215.

As has been described, automated rule generation engine 200 is operable to generate multiple rules. Once an entire rule has been generated by rule formation module 230, repeat instruction 238 can be issued to repeat the process. In response, root node selection module 320 is operable to instantiate a different root node condition, and thus initiate generation of a different tree data structure, and subsequently another rule. In some cases, this process repeats until root node selection module 320 uses every feature of feature set 205 for a root node of different trees. In some embodiments, this process repeats until a majority of features in feature set 205 are utilized. In general, the number of trees that may be generated can vary in different embodiments.

To further explain the operation of decision stump training module 310A, FIG. 3B illustrates an example of a decision stump. Decision stump 380 includes root node 382, filtered datasets 332A-B, and root-level branches 390A-B. As explained with reference to FIG. 3A, root node selection module 320 is operable to output a root node decision condition (A≥1) as root node information 315 for root node 382.

Root node branch generation module 330 is operable to apply the root node decision condition to filter a dataset, such as dataset 110, into filtered datasets 332A-B via root-level branches 390A-B (true and false, respectively). Information gain determination module 340 is operable to determine information gains 334A-B, respectively, for filtered datasets 332A-B. Information gain selector 350 indicates, using information gain indicator 336, that filtered dataset 334B has the greatest information gain. Accordingly, dataset selector 360 selects filtered dataset 334B as selected filtered root-level dataset 218. Because the “false” root-level branch 390 has been selected, inverter logic 370 operates to invert the ≥operator to output A<1 as selected root-level branch 215. Decision stump training module 310A is described above with respect to FIG. 3A generates a decision stump with a root node against which dataset 110 is evaluated for the true and false root-level branches. This paradigm may be referred to as the “first condition approach.” As has been described, in the first-condition approach the split of the root node is given by the maximum information gain.

A different paradigm for root node generation may be referred to as the “first-condition quantile approach.” In this paradigm, the operator may be selected based on expert domain knowledge of all the features, but the best threshold may not be easily discernible using expert domain knowledge. Because a single ideal threshold for a feature is not easily obtainable, the idea in the first-condition quantile approach is to use multiple threshold values (i.e., different quantiles) for a given feature.

Additional changes to the first condition approach may be employed if the training dataset in question is imbalanced or skewed—that is, only some small percentage (e.g., 1%) of the events in the dataset correspond to the class that is being predicted (e.g., fraud determination). In such cases, the quantile ranges can be reduced as follows:

If the operator is > or ≥, only quantiles at the upper end of the range of values may be considered (e.g., between 80% and 100% (excluded) of the max values for the feature). Thus, if ten rules are desired for a given feature A, the root node decision conditions will be as follows: A>80% [of max feature value], A>82%, A>84%, . . . A>98%.

If the operator is < or ≤, only quantiles at the lower end of the range of values may be considered (e.g., between 0% (excluded) and 20% of the min values for the feature). Thus, if ten rules are desired for a given feature A, the root node decision conditions will be as follows: A<2% [of min feature value], A<4%, A<6%, . . . A<20%. The foregoing are examples only. It is understood that the percentages may vary.

In some embodiments, the first-condition approach will use every feature of the dataset once and only once in the root node. As has been explained, this leads to a low level of correlation between results generated from applying the rules as compared with using standard approaches such as the Random Forest approach in which only a small number of possible features will be used in the root nodes of generated trees. In contrast, in some embodiments of the first-condition quantile approach, every feature of the dataset will be used M times in the root node of a generated tree, where M is the number of desired quantiles. This leads to a low level of correlation between results generated from applying the different first condition rules.

FIG. 3C is a block diagram of one embodiment of a decision stump training module that is operable to implement the first-condition quantile approach. As depicted, decision stump training module 310B, which includes root node selection module 311 and root node branch generation module 320. These modules work in a similar fashion to those described above with reference to FIG. 3B.

Root node selection module 311, however, is operable in the depicted embodiment to instantiate a plurality of root nodes for a given feature based on quantile parameters 352. Quantile parameters 352 may include, in one embodiment, a range of values, the number of quantiles, as well as the value of the current quantile being generated. As noted, based on the selected operator (e.g., <. >, etc.), root node selection module 311 may determine which portion of the feature value to quantize. For instance, when the operator is < or ≤, root node selection module 311 may select a range between 0% (excluded) and 20% of the minimum values corresponding to the feature. The precise bounds of either end of the spectrum may vary, and can be specified by quantile parameters 352. As another example, when the operator is > or ≥, root node selection module 311 may select a range between 80% and 100% (excluded) of the maximum values corresponding to the feature.

In response to receipt of root node information 315 and dataset 110, root node branch generation module 320 is operable to apply root node information 315 to dataset 110. Unlike the first-condition approach described with reference to FIG. 3A, in which filtered root-level dataset 218 and selected root-level branch 215 are selected based on information gain, root node branch generation module 320 selects, as filtered root-level dataset 218, the filtered dataset corresponding to the “true” branch relative to the applied condition, along with the condition specified by root node information 315 as selected root-level branch 215.

Once a particular root node is instantiated by decision stump training module 310B along with a root node decision condition, filtered root-level dataset 218 and selected root-level branch 215 are passed along to decision tree training module 220 to complete generation of the remaining rule conditions. Rule formation module 230 combines the first condition and the remaining rule conditions into a final rule for potential inclusion in the rule set. Rule formation module then issues a repeat instruction 238 to root node selection module 311.

In response to receipt of repeat instruction 238, root node selection module 311 will instantiate a root node for a new decision tree based on the number of the current quantile being generated, a quantile size, etc. For example, suppose the feature is A, the selected range is 0% to 20% of the minimum values corresponding to the feature, the number of quantiles is 4, and a root node for 1 quantile has already been generated (i.e., A<5% of maximum feature value). Root node selection module 311 would then be operable to instantiate a root node having root node decision condition A<10%. Successive iterations would create root node with decision conditions A<15% and A<20%.

FIG. 3D is a table that is an example of root nodes that may be instantiated using the first-condition quantile approach. As depicted, depending on the operator, root node selection module 311 is operable to identify a suitable root node condition range. Additionally, root node selection module 311 is further operable to divide the root node condition range into quantiles (here, four quantiles), based on quantile parameters 352.

FIG. 3E depicts two tables illustrating how features A-J in a feature set might be utilized by root node selection module 311 for both the first-condition approach and the first-condition quantile approach (table 394). In one implementation of the first-condition approach that is illustrated in table 392, root node selection module 311 is operable to generate ten trees, using each feature of the feature set as a root node once an only once. In contrast, table 394 shows one implementation of the first-condition quantile approach having 4 quantiles, in which 40 trees are generated, 4 for each of the 10 different features.

Note that in other implementations of these approaches, the maximum number of trees do not necessarily have to be generated. For example, the first-condition approach might be used to generate a decision using a majority of the features in the feature set. The same approach might also be employed with respect to the first-condition quantile approach.

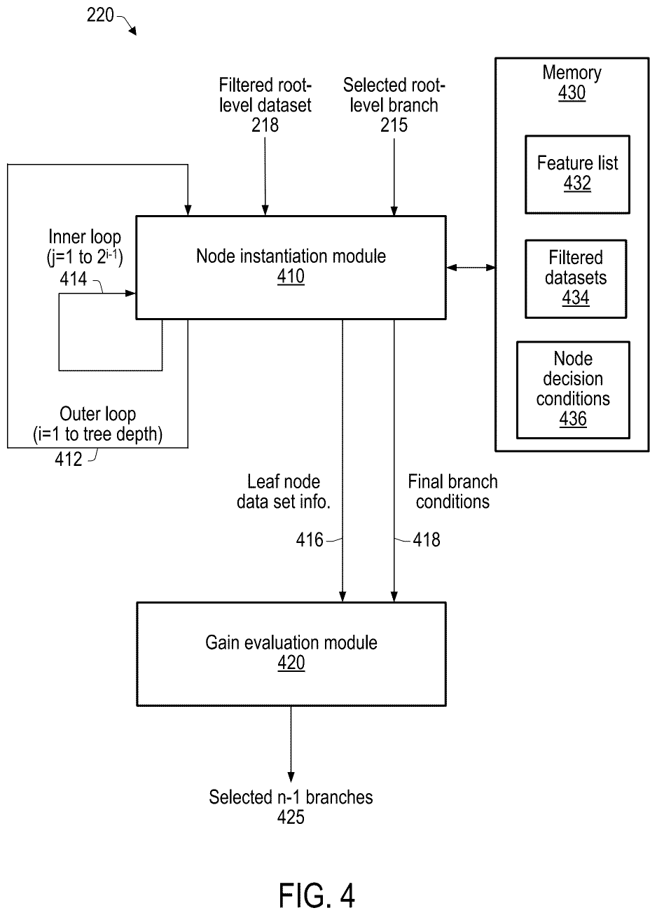

FIG. 4 is a block diagram of one embodiment of a decision tree training module. As depicted, decision tree training module 220 includes node instantiation module 410, gain evaluation module 420, and has access to memory 430. Decision tree training module 220 is operable to instantiate tree data structure to a depth of n−1, below the root level branches that are instantiated by decision stump training module.

Node instantiation module 410 is operable to access memory 430 to access and store different types of data, including feature list 432, filtered datasets 434, and node decision conditions 436. As the lower levels of a tree are being instantiated, feature list 432 can be used to determine what features have not yet been included in the tree. Filtered datasets 434 are those datasets that are created from filtered root-level dataset 218 from the root node as the nodes in the lower levels of the tree are instantiated with node decision conditions and evaluated. For Z events in filtered root-level dataset 218, these Z events will ultimately be distributed over the 2ⁿ⁻¹ final filtered datasets associated with level n of the tree. In order to compute these final filtered datasets, the filtered “parent” dataset for the current node is accessed and evaluated, producing two “child” filtered datasets (T and F). In the next level, these “child” filtered datasets become parent filtered datasets and the process continues. In some embodiments, whenever a filtered dataset is created by node instantiation module 410, the corresponding set of node decision conditions for that filtered dataset are stored in node decision conditions 436. In this manner, when a given final filtered dataset is determined to have the greatest IG by gain evaluation module 420, the node decision conditions associated with the determined final filtered dataset can readily be determined as well.

Node instantiation module 410 is operable to receive filtered root-level dataset 218 and selected root-level branch 215 from decision stump training module 210. To instantiate the tree data structure to an n−1 depth, node instantiation module 410 implements outer loop 412 and inner loop 414. Outer loop 412 iterates through an index i ranging from 1 (e.g., corresponding to the root level branch) to one less than the tree depth, n−1. Inner loop 414 iterates from an index j ranging from 1 to 2⁽ⁱ⁻¹⁾, and is responsible for 1) generating the nodes at a given level of the tree, including the node decision condition, 2) evaluating the branches for each node at that level, and 3) storing current filtered data sets and rules corresponding to that level.

At the root level branch (i=1, j=1), node instantiation module 410 calls a function to generate a node decision condition. To do so, module 410 selects, from feature list 432, a feature that was not previously used with the decision tree, and associates a node condition with the selected feature (e.g., B≤32). Module 410 applies the node decision condition to the filtered data set of the parent node (filtered root-level dataset 218 in the first iteration of the inner loop), causing filtered root-level dataset 218 to be further filtered into a current node true dataset and into a current node false dataset. These datasets will be used in lower levels of the decision tree and can be stored in one or more arrays since multiple filtered datasets will be computed at a given tree level. Additionally, module 410 stores the conditions corresponding to each filtered dataset so that when a final filtered dataset is chosen by gain evaluation module 420, the corresponding conditions can be captured as selected (n−1) branches 225.

In the first iteration of inner loop 414, the loop code is performed only once since there is only one node to be instantiated. During a second iteration (i=2) of inner loop 414, the loop code is performed twice (since 2ⁱ⁻¹=2¹=2), instantiating nodes with node decision conditions for both the true and false branches of the first (and only) node in the previous level. The decision condition of each instantiated node is evaluated with respect to the filtered dataset associated with its parent node, creating a new current node true dataset and current node false dataset to add to an array for the current tree level along with the associated rules.

After the second iteration of inner loop 414 is performed, the counter of the outer loop 412 is incremented and, if that counter does not exceed the tree depth parameter, the inner loop is performed again. This process continues until filtered datasets and their associated rules are stored for the nth level of the tree, or (n−1) levels below the root node. Module 410 outputs, to gain evaluation module 420, final filtered dataset information 416 and associated final branch conditions 418. Note that information 416 may include pointers or other indications of these datasets.

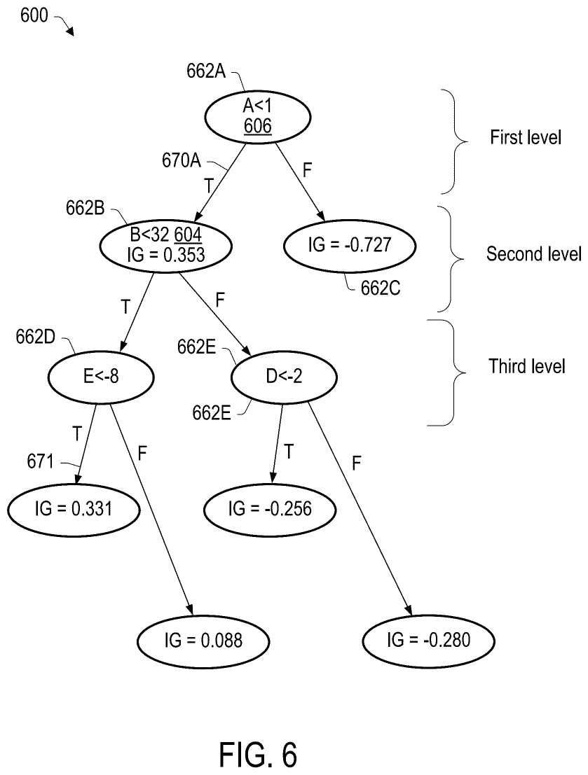

Gain evaluation module 420 is operable to determine an information gain of each final filtered dataset. In one embodiment, this may be performed by setting an initial value for maximum IG and then looping over each final filtered dataset. In each iteration, the IG for the current final filtered dataset will be computed, and if it exceeds the current maximum IG value, it will replace current maximum IG value. Additionally, the set of branches associated with that final filtered dataset will be stored as the corresponding current set of branches. When such a loop completes, the set of branch conditions associated with the final filtered dataset having the maximum IG will be output as selected n−1 branches 225. This process will be illustrated further with respect to FIG. 6.

FIG. 5 is a block diagram of one embodiment of a rule formation module, a rule storage, and a rule set optimization module. As depicted, rule formation module 230, rule storage 510, and rule set optimization module 240 are operable to generate an optimized rule set.

Rule formation module 230 is operable to receive selected root-level branch 215, corresponding to the leaf node decision condition, and to receive selected n−1 level branches 225, corresponding to n−1 node decision conditions (e.g., node decision conditions associated with nodes other than the root level node). Rule formation module 230 is operable to concatenate selected root-level branch 215 and selected n−1 level branch to output an n-condition rule 225. As depicted in FIG. 5, rule formation module 230 is then operable to execute repeat instruction 238 to operate iteratively to generate a plurality of n-condition rules.

Rule storage 510 is operable to receive n-conditions rules, such as n-condition rule 232, output by rule formation module 230. Rule storage 510 is further operable to store the n-condition rules, constituting rule set 235. Rule storage 510 may correspond to an addressable memory such that rule optimization module 240 is operable to look-up and access n-conditions rules of rule set 235.

Rule optimization module 240 includes rule selection module 520 and rule optimization module 530. Rule selection module 520 is operable to retrieve rule set 235 from rule storage 510. Rule optimization module 530 is operable to apply received selection parameter(s) 250 to select n-condition rules to output optimized rule set 245. The rule selection parameter(s) may correspond to heuristics regarding indicia of rule quality. For example, the selection parameter(s) 250 may correspond to industry standards. Accordingly, rule optimization module 530 may use the industry standards to generate optimized rule set 245.

FIG. 6 is a block diagram of a tree data structure generated as an output of the disclosed rule generation engine. As depicted, tree data structure 600 having node 662A at a first tree level, node 662B at a second tree level, and nodes 662D and 662E at a third tree level. Tree data structure thus has a tree depth of n=3. Generation of tree data structure will be described with regard to previously described code modules. Decision stump training module 210 instantiates root node 662A that is associated with root node decision condition 606, which, when applied to dataset 110, creates two filtered datasets, associated with elements of dataset 110 that do and do not satisfy root node decision condition 606, respectively. Decision stump training module 210 computes information gain for these two filtered datasets (0.353 and −0.727, respectively). Decision stump training module 210 then selects branch 670A for further processing since it has the greater information gain. Branch 670A thus corresponds to selected root-level branch 215 and the selected filtered dataset is filtered root-level data 218. Notably, the false branch of node 662A (i.e., the branch having lower information gain) does not undergo further processing, thereby conserving computational resources.

Decision stump training module 210 passes information corresponding to selected root-level branch 215 and to filtered root-level data 218 to decision tree training module 220, which completes tree data structure 600. To this end, node instantiation module 410 executes outer loop 412 twice. In the first iteration, module 410 instantiates node 662B along with is node decision condition, and then evaluates the filtered dataset associated with branch 670A to create additional filtered datasets for the T and F branches of node 662B. The respective rules associated with these filtered datasets are also stored (B<32 and B≥32).

In the second iteration of outer loop 412, inner loop 414 is executed twice since 2⁽ⁱ⁻¹⁾ is equal to 2 when i=1. In the iteration defined by (i=2, j=1), node 662D is instantiated along with node decision condition E<8, and then the filtered dataset for the T branch of node 662B is evaluated, creating final filtered datasets for the T and F branches of node 662D. These datasets have respective IGs of 0.331 and 0.088. In the iteration defined by (i=2, j=2), node 662E is instantiated along with node decision condition D<−2, and then the filtered dataset for the F branch of node 662B is evaluated, creating final filtered datasets for the T and F branches of node 662E. These datasets have respective IGs of −0.256 and −0.280.

Node instantiation module 410 passes the final filtered datasets associated with nodes 662D-E to gain evaluation module 420, along with information that specifies the set of conditions associated with these filtered dataset. Gain evaluation module 420 computes IG values associated for the two filtered T/F datasets associated with node 662D and for the two filtered T/F datasets associated with node 662E. Gain evaluation module 420 then compares these computed IG values and selects branch 671, associated with the true branch of node 662D as having the greatest IG. The conditions that are associated with this branch (i.e., B<32 and E<−8) are then output by gain evaluation module 420 as selected n−1 branches 425.

Selected root-level branch 215 (A<1) and selected n−1 branches 425 (B<32, E <−8) are then concatenated by rule formation module 230 to generate n-condition rule 235 (A<1, B<32, E<−8). The resulting rule may be chosen for inclusion in optimized rule set 245 if certain criteria are met.

Note that in the first-condition quantile mode of operation, decision tree 600 would be generated in a similar fashion, except that decision stump training module 210 automatically selects true branch 670A of the root node for further processing and the false branch is not evaluated further. Subsequent steps in the first-condition quantile approach are the same as those in the first-condition approach, however.

The first condition approach set forth in the present disclosure is less time complex than the traditional Random Forest approach due, at least in part, to not performing further processing of the root-level branch having the lesser information gain. The traditional Random Forest approach has time complexity O(j*k!/((k−n)!), where j denotes the number of trees, k denotes the number of features, and n denotes the tree depth. In contrast, the first condition approach described herein has time complexity O(k*(k−1)!*(k−n)!). This represents a runtime reduction of O(j*n) relative to Random Forest time complexity.

Thus, comparing the foregoing equations, the reduction in time complexity associated with the present disclosure is as follows:

$$O ( j * k ) when j \leq k ; and$$

$$O ( j * k ) + O ( ( j - k ) * k ! / ( k - n ) ! ) when j > k .$$

This reduced time complexity advantageously leads to more rapid rule set creation than through use of traditional techniques (e.g., the Random Forest approach).

A comparison of the compute times and F1-score of the optimized rule sets generated by a standard approach, a standard approach with a large Random Forest, a first-condition approach, and a first-condition quantile approach are shown in the table below:

TABLE 1

| | | | Number | | |
|---|---|---|---|---|---|
| | Number | | of | Runtime | F-1 score |
| Approach | of | Number | selected | (without | optimized |
| Type | features | of trees | rules | parallelization) | ruleset |
| Standard | 100 | 100 | 11 | ~2 minutes | 0.4 |
| approach | | | | | |
| Standard | 100 | 10,000 | 1,222 | ~100 minutes | 0.45 |
| approach | | | | | |
| with a | | | | | |
| large | | | | | |
| forest | | | | | |
| First- | 100 | 100 | 72 | ~2 minutes | 0.47 |
| condition | | | | | |
| approach | | | | | |
| First- | 100 | 100 | 83 | ~2 minutes | 0.49 |
| condition | | | | | |
| quantile | | | | | |
| approach | | | | | |

A higher F-1 score indicates that a ruleset is better suited to identifying a characteristic of interest in a dataset. This table data, which is merely exemplary of one possible implementation, indicates that better rule sets may be generated using the disclosed techniques without sacrificing performance.

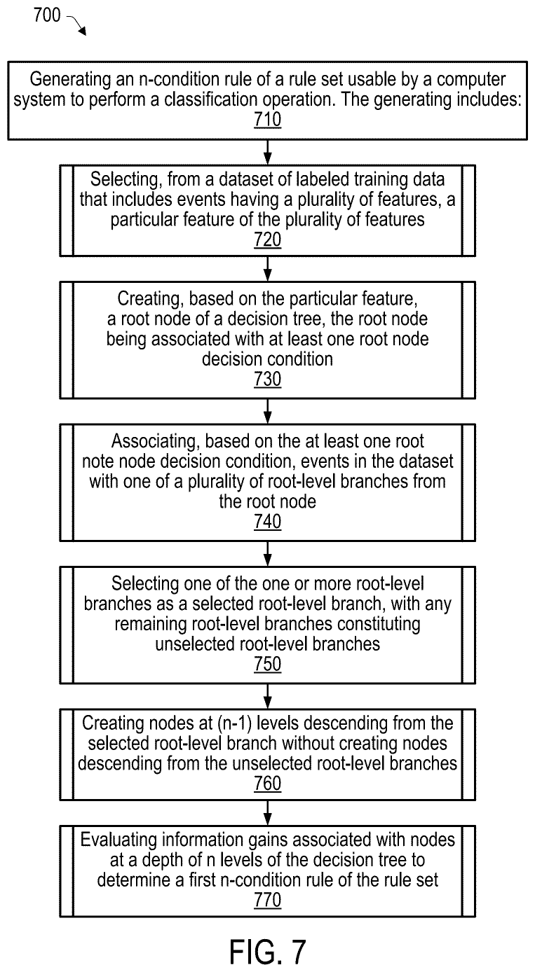

FIG. 7 is a flow diagram of one embodiment of a method for automated rule generation. Method 700 may be performed by an automated rule generation system. For example, method 700 may be performed by automated rule generation system 200. Method 700 has many variations, including those described below.

Method 700 includes, at 710, generating an n-condition rule of a rule set usable by a computer system to perform a classification operation.

Generating the n-condition rule of the rule set includes, at 720, selecting, from a dataset of labeled training data that includes events having a plurality of features, a particular feature of the plurality of features.

Additionally, generating the n-condition rule of the rule set includes, at 730, creating, based on the particular feature, a root node of a decision tree, the root node being associated with at least one root node decision condition.

Further, generating the n-condition rule of the rule set includes, at 740, associating, based on the at least one root node decision condition, events in the dataset with one of a plurality of root-level branches from the root node.

Moreover, generating the n-condition rule of the rule set includes, at 750, selecting one of the plurality of root-level branches as a selected root-level branch, with remaining root-level branches constituting unselected root-level branches.

Additionally, generating the n-condition rule of the rule set includes, at 760, creating nodes at (n−1) levels descending from the selected root-level branch without creating nodes descending from the unselected root-level branches.

Further, generating the n-condition rule of the rule set includes, at 770, evaluating information gains associated with nodes at a depth of n levels of the decision tree to determine a first n-condition rule of the rule set.

In some embodiments, method 700 further includes repeating the generating using different features of the plurality of features to produce additional n-condition rules of the rule set.

In some embodiments, method 700 further includes repeating the generating to produce a plurality of decision trees in which each of the plurality of features is used to generate at least one root node of the plurality of decision trees. The plurality of decision trees correspond to a plurality of n-condition rules of the rule set.

In some embodiments, the one or more root level branches is associated with a binary condition that has two branches, a first branch for which the binary condition is true and a second branch for which the binary condition is false. In some embodiments, the selecting the one or more root-level branches is based on which of the first or second branches has a greater amount of information gain.

In some embodiments, the one or more root level branches is associated with a binary condition that has a single branch for which the binary condition is true, and which is the selected branch.

In some embodiments, method 700 further includes repeating the generating to form additional n condition rules using the particular feature with differing root node decision conditions to create multiple n-condition rules based on the particular feature.

In some embodiments, the nodes created at the (n−1) levels descending from the selected root-level branch are associated with remaining ones of the plurality of features and have corresponding node decision conditions that assess numeric values for the remaining features.

In some embodiments, the classification operation is for classifying fraudulent electronic transactions.

In some embodiments, the classification operation is for classifying malicious computer network activity.

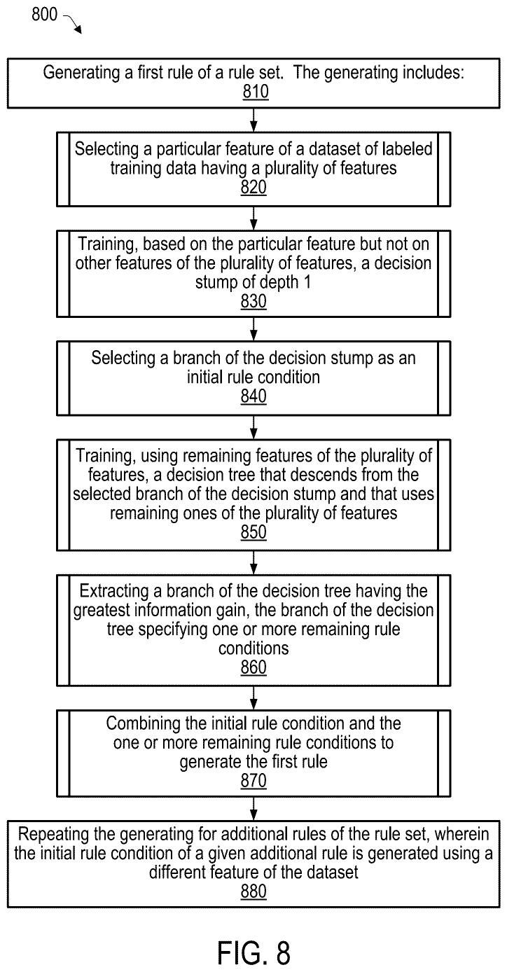

FIG. 8 is a flow diagram of one embodiment of a method for automated rule generation. Method 800 may be performed by an automated rule generation system. For example, method 800 may be performed by automated rule generation system 200. Method 800 has many variations, including those described below.

Method 800 includes, at 810, generating a first rule of a rule set.

Generating the first rule of the rule set includes, at 820, selecting a particular feature of a dataset of labeled training data having a plurality of features.

Additionally, generating the first rule of the rule set includes, at 830, training, based on the particular feature but not on other features of the plurality of features, a decision stump of depth 1.

Further, generating the first rule of the rule set includes, at 840, selecting a branch of the decision stump as an initial rule condition.

Moreover, generating the first tule of the rule set includes, at 850, training, using remaining features of the plurality of features, a decision tree that descends from the selected branch of the decision stump and that uses remaining ones of the plurality of features.

Further, generating the first tule of the rule set includes, at 860, extracting a branch of the decision tree having the greatest information gain, the branch of the decision tree specifying one or more remaining rule conditions.

Additionally, generating the first tule of the rule set includes, at 870, combining the initial rule condition and the one or more remaining rule conditions to generate the first rule.

Method 800 additionally includes, at 880, repeating the generating for additional rules of the rule set, wherein the initial rule condition of a given additional rule is generated using a different feature of the dataset.

In some embodiments, respective decision stumps for the first rule and the additional rules are based on different ones of the plurality of features.

In some embodiments, the first rule and the additional rules have decision stumps corresponding to a majority of the plurality of features in the dataset.

In some embodiments, the decision stump is associated with a binary condition and has two branches, a first branch for which the binary condition is true and a second branch for which the binary condition is false. In some embodiments, the branch of the decision stump is selected based on which of the first or second branches has a greater amount of information gain.

In some embodiments, the decision stump is associated with a binary condition and has a single branch for which the binary condition is true, and which is the selected branch.

In some embodiments, method 800 further includes repeating the generating to form additional decision stumps trained using the particular feature but with differing initial rule conditions to create multiple rules based on the particular feature.

In some embodiments, method 800 further includes selecting rules from the rule set that satisfy a set of heuristics; and using the selected rules to generate an optimized rule set.

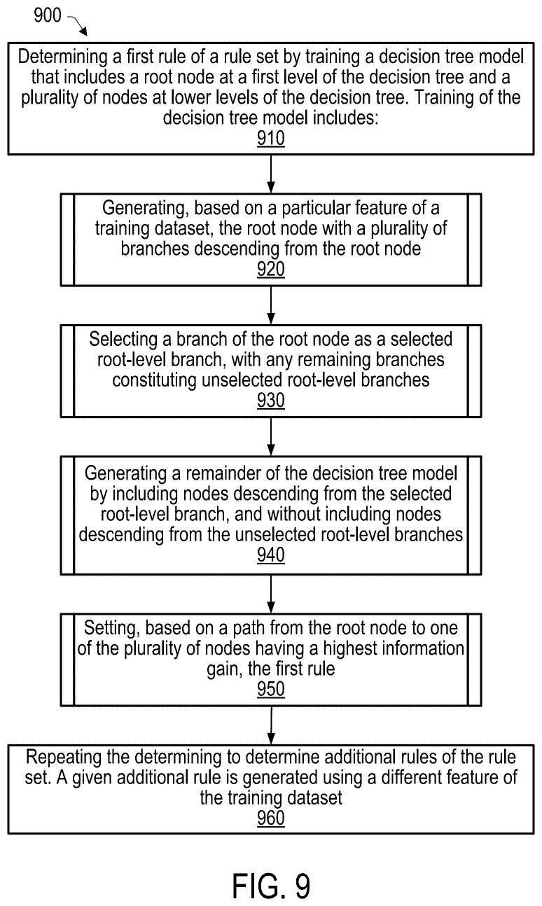

FIG. 9 is a flow diagram of one embodiment of a method for automated rule generation. Method 900 may be performed by an automated rule generation system. For example, method 900 may be performed by automated rule generation system 200. Method 900 has many variations, including those described below.

Method 900 includes, at 910, determining a first rule of a rule set by training a decision tree model that includes a root node at a first level of the decision tree and a plurality of nodes at lower levels of the decision tree.

Training the decision tree model includes., at 920, generating, based on a particular feature of a training dataset, the root node with a plurality of branches descending from the root node.

Additionally, training the decision tree model includes, at 930, selecting a branch of the root node as a selected root-level branch, with any remaining branches constituting unselected root-level branches.

Further, training the decision tree model includes, at 940, generating a remainder of the decision tree model by including nodes descending from the selected root-level branch, and without including nodes descending from the unselected root-level branches.

Moreover, training the decision tree model includes, at 950, setting, based on a path from the root node to one of the plurality of nodes having a greatest information gain, the first rule.

Additionally, method 900 includes, at 960, repeating the determining to determine additional rules of the rule set. A given additional rule is generated using a different feature of the training dataset.

In some embodiments, the at least one branch includes a first root-level branch for events that satisfy a root node decision condition and a second root-level branch for events that do not satisfy the root node decision condition. In some embodiments, the selected root-level branch corresponds to which of the first and second root-level branches has a greater information gain. In some embodiments, the at least one branch has a single branch for events that do not satisfy a root node decision condition.

In some embodiments, method 900 includes repeating the determining to determine multiple rules for the particular feature, wherein a given one of the multiple rules is based on a particular operator and a unique threshold.

Various techniques described herein, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

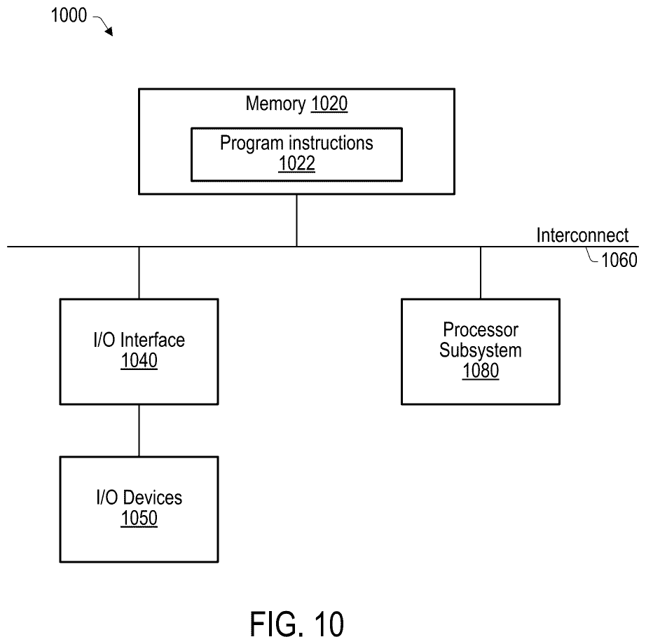

Similarly, systems that implement the methods described with respect to any of the disclosed techniques are also contemplated. One such system is described with reference to FIG. 10. FIG. 10 is a block diagram of another embodiment of such a computer system. Computer system 1000 includes a processor subsystem 1080 that is coupled to a system memory 1020 and I/O interfaces(s) 1040 via an interconnect 1060 (e.g., a system bus). I/O interface(s) 1040 is coupled to one or more I/O devices 1050. Computer system 1000 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 1000 is shown in FIG. 10 for convenience, system 1000 may also be implemented as two or more computer systems operating together.

Processor subsystem 1080 may include one or more processors or processing units. In various embodiments of computer system 1000, multiple instances of processor subsystem 1080 may be coupled to interconnect 1060. In various embodiments, processor subsystem 1080 (or each processor unit within 1080) may contain a cache or other form of on-board memory.

System memory 1020 is usable to store program instructions executable by processor subsystem 1080 to cause system 1000 perform various operations described herein. System memory 1020 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 1000 is not limited to primary storage such as memory 1020. Rather, computer system 1000 may also include other forms of storage such as cache memory in processor subsystem 1080 and secondary storage on I/O Devices 1050 (e.g., a hard drive, storage array, etc.). In some embodiments, these other forms of storage may also store program instructions executable by processor subsystem 1080.

I/O interfaces 1040 may be any of various types of interfaces configured to couple to and communicate with other devices, according to various embodiments. In one embodiment, I/O interface 1040 is a bridge chip (e.g., Southbridge) from a front-side to one or more back-side buses. I/O interfaces 1040 may be coupled to one or more I/O devices 1050 via one or more corresponding buses or other interfaces. Examples of I/O devices 1050 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1000 is coupled to a network via a network interface device 1050 (e.g., configured to communicate over WiFi, Bluetooth, Ethernet, etc.).

Memory 1020 may include a non-transitory computer-readable storage medium storing program instructions 1022 in various embodiments. Program instructions 1022 may include instructions that are executable to perform methods 700-900, for example.

One particular environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” be used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
generating an n-condition rule of a rule set usable by a computer system to perform a classification operation, the generating including:
selecting, from a dataset of labeled training data that includes events having a plurality of features, a particular feature of the plurality of features;
creating, based on the particular feature, a root node of a decision tree, the root node being associated with a root node decision condition;
associating, based on the root node decision condition, events in the dataset with one or more root-level branches from the root node;
selecting one of the one or more root-level branches as a selected root-level branch, with any remaining root-level branches constituting unselected root-level branches;
creating nodes at (n−1) levels descending from the selected root-level branch without creating nodes descending from the unselected root-level branches; and
evaluating information gains associated with nodes at a depth of n levels of the decision tree to determine a first n-condition rule of the rule set.

2. The method of claim 1, further comprising:
repeating the generating using different features of the plurality of features to produce additional n-condition rules of the rule set.

3. The method of claim 1, further comprising repeating the generating to produce a plurality of decision trees in which each of the plurality of features is used to generate at least one root node of the plurality of decision trees, the plurality of decision trees corresponding to a plurality of n-condition rules of the rule set.

4. The method of claim 1, wherein the one or more root-level branches is associated with a binary condition that has two branches, a first branch for which the binary condition is true and a second branch for which the binary condition is false, and wherein the selecting the one or more root-level branches is based on which of the first or second branches has a greater amount of information gain.

5. The method of claim 1, wherein the one or more root-level branches is associated with a binary condition that has a single branch for which the binary condition is true, and which is the selected root-level branch.

6. The method of claim 1, further comprising:
repeating the generating to form additional n condition rules using the particular feature with differing root node decision conditions to create multiple n-condition rules based on the particular feature.

7. The method of claim 1, wherein the nodes created at the (n−1) levels descending from the selected root-level branch are associated with remaining ones of the plurality of features and have corresponding node decision conditions that assess numeric values for the remaining ones of the plurality of features.

8. The method of claim 1, wherein the classification operation is for classifying fraudulent electronic transactions.

9. The method of claim 1, wherein the classification operation is for classifying malicious computer network activity.

10. A non-transitory computer-readable storage medium storing program instructions executable on a computer system to perform operations comprising:
generating a first rule of a rule set, wherein the generating includes:
selecting a particular feature of a dataset of labeled training data having a plurality of features;
training, based on the particular feature but not on other features of the plurality of features, a decision stump of depth 1;
selecting a branch of the decision stump as an initial rule condition;
training, using remaining features of the plurality of features, a decision tree that descends from the selected branch of the decision stump and that uses remaining ones of the plurality of features;
extracting a branch of the decision tree having a greatest information gain, the branch of the decision tree specifying one or more remaining rule conditions; and
combining the initial rule condition and the one or more remaining rule conditions to generate the first rule; and
repeating the generating for additional rules of the rule set, wherein the initial rule condition of a given additional rule is generated using a different feature of the dataset.

11. The computer-readable storage medium of claim 10, wherein respective decision stumps for the first rule and the additional rules are based on different ones of the plurality of features.

12. The computer-readable storage medium of claim 10, wherein the first rule and the additional rules have decision stumps corresponding to a majority of the plurality of features in the dataset.

13. The computer-readable storage medium of claim 10, wherein the decision stump is associated with a binary condition and has two branches, a first branch for which the binary condition is true and a second branch for which the binary condition is false, and wherein the branch of the decision stump is selected based on which of the first or second branches has a greater amount of information gain.

14. The computer-readable storage medium of claim 10, wherein the decision stump is associated with a binary condition and has a single branch for which the binary condition is true, and which is the selected branch.

15. The computer-readable storage medium of claim 10, wherein the operations further comprise:
repeating the generating to form additional decision stumps trained using the particular feature but with differing initial rule conditions to create multiple rules based on the particular feature.

16. The computer-readable storage medium of claim 10, wherein the operations further comprise:
selecting rules from the rule set that satisfy a set of heuristics; and
using the selected rules to generate an optimized rule set.

17. A method, comprising:
determining a first rule of a rule set by training a decision tree model that includes a root node at a first level of a decision tree and a plurality of nodes at lower levels of the decision tree, wherein training of the decision tree model includes:
generating, based on a particular feature of a training dataset, the root node with at least one branch descending from the root node;
selecting a branch of the root node as a selected root-level branch, with any remaining branches constituting unselected root-level branches;
generating a remainder of the decision tree model by including nodes descending from the selected root-level branch, and without including nodes descending from the unselected root-level branches;
setting, based on a path from the root node to one of the plurality of nodes having a greatest information gain, the first rule; and
repeating the determining to determine additional rules of the rule set, wherein a given additional rule is generated using a different feature of the training dataset.

18. The method of claim 17, wherein the at least one branch includes a first root-level branch for events that satisfy a root node decision condition and a second root-level branch for events that do not satisfy the root node decision condition, wherein the selected root-level branch corresponds to which of the first and second root-level branches has a greater information gain.

19. The method of claim 17, wherein the at least one branch has a single branch for events that do not satisfy a root node decision condition.

20. The method of claim 19, further comprising:
repeating the determining to determine multiple rules for the particular feature, wherein a given one of the multiple rules is based on a particular operator and a unique threshold.
